(19) United States
(12) Patent Application Publication
(10) Pub. No.: US 2025/0315973 A1
(43) Pub. Date: Oct. 9, 2025

(54) A SYSTEM FOR OBTAINING DATA ON A POSITION OF A SPRAY GUN RELATIVE TO A SURFACE PROVIDED IN A SPACE

(71) Applicant: Proxcontrol IP B.V., Ijmuiden (NL)

(72) Inventors: Rob KEIJ, Heerhugowaard (NA); Ronnie Jacobus Samuel NIEUWENBURG, Harderwijk (NL); Remy Michel SERRUIJS, IJmuiden (NL); Petrus Elbertus Marie BRANDJES, Amsterdam (NL)

(21) Appl. No.: 18/865,439

(22) PCT Filed: May 12, 2023
(86) PCT No.: PCT/NL2023/050264

§ 371 Date: Nov. 13, 2024

(30) Foreign Application Priority Data
May 13, 2022 (NL) 2031854

(51) Int. Cl. G06T 7/73; B05B 12/08

(52) U.S. Cl. CPC G06T 7/73; B05B 12/082

(57) ABSTRACT

A system is provided for obtaining data on a position of a spray gun relative to a surface to be coated provided in a space, comprising a data acquisition device. The data acquisition device comprises a spray gun mount arranged to rigidly connect the device to the spray gun, a beacon sensor module arranged to receive beacon data from one or more reflective beacons located in the space, a surface scanning module arranged to scan the surface and to provide scanning data by scanning the surface and a processing unit. The processing unit is arranged to receive the beacon data, based on the beacon data, determine localisation data indicating a location of the device within the space; and based on the localisation data and the scanning data, determine position data indicating a position of the spray gun relative to the surface.

### TECHNICAL FIELD

The invention relates to a sensor kit for a spray gun and processing of data received from the sensor kit.

### BACKGROUND

Spray painting is a technique of using a spray gun to spray a coating through the air onto a surface. The coating may be a paint, ink, varnish, clear coat, or any other type of coating. A spray gun may be hand-held by an operator, and it may require significant skill to apply a thin coating with consistent layer thickness. Whether or not the operator has skill, final thickness of the layer may vary, which may have an impact on durability of the coating and reliability of sensors covered by the coating, like proximity radar systems of cars.

### SUMMARY

In order to track the result of the coating process, it is preferred to have data on the final layer of coating available, in particular with respect to an amount of coating material available on the surface to coat, per unit of area. For obtaining such data, proper localisation of a spray gun or a spray cone emitted by the spray gun relative to an object or a surface to be coated is preferred to be available.

A first aspect provides a system for obtaining data on a position of a spray gun relative to a surface to be coated provided in a space, comprising a data acquisition device. The data acquisition device comprises a spray gun mount arranged to rigidly connect the device to the spray gun, a beacon sensor module arranged to receive beacon data from one or more reflective beacons located in the space, a surface scanning module arranged to scan the surface and to provide scanning data by scanning the surface and a processing unit. The processing unit is arranged to receive the beacon data, based on the beacon data, determine localisation data indicating a location of the device within the space; and based on the localisation data and the scanning data, determine position data indicating a position of the spray gun relative to the surface.

The beacons provide a fixed reference relative to the surface to be coated. By moving the device, mounted on a spray gun arranged to provide a spray of coating fluid, relative to the beacon, by monitoring the beacon and subsequently processing the acquired beacon data, a position of the device and with that, of the spray gun, relative to the beacon or beacons may be determined. By scanning the surface with the same device and based upon the scanning data and localisation data, determine a position of the device relative to the surface, the actual position of the spray gun relative to the surface may be determined, for example over time. The scanning hardware and the beacon localisation hardware may be provide in one and the same housing or in different housings, in the latter case the device is constituted by two separate modules. An advantage of using reflective beacons is that no active beacons have to be used. An advantage thereof is that such beacons can be applied in, for example, a spray booth, without for example having to requalify the spray booth for explosion hazards or other risks that active beacons may introduce.

In an example, the beacon sensor module comprises a first optical sensor arranged to capture light reflected by a visual beacon and to provide first image data representing the reflected light; and the processing unit is further arranged to identify data related to the beacon in the first image data as first received beacon data, obtain beacon reference data, compare the received beacon data to the beacon reference data, based on the comparing, determine a relative position of the device relative to the beacon; and provide the determined position as localisation data. Depending on distance of the device and the sensor in particular to the beacon and depending on and angle of the sensor relative to the beacon—or beacons—, visual data related to the beacon is captured in a particular way. The received image may provide a certain distorted view of the marker and/or may capture more or less area of the captured image, depending on angle and distance. By comparing the captured data to reference data, one or two of distance and angle of the device relative to the beacon may be determined by determining distortion and/or size relative to a reference image.

In another example, the beacon sensor module comprises a first optical sensor having a first field of view and a second optical sensor having a second field of view, the first field of view overlapping at least partially with the second field of view; and the processing unit is further arranged to identify data related to the beacon in the first image data as first received beacon data, identify data related to the beacon in the second image data as second received beacon data, compare the first received beacon data to at least one of the second received beacon data and reference beacon data, based on the comparing, determine a relative position of the device relative to the beacon; and provide the determined position as localisation data. The reference image may be stored in a memory prior to a spray job. Alternatively or additionally, two images are acquired by, preferably, adjacent image sensors and differences are determined. Based on such differences, one or two of distance and angle of the sensors and hence, of device and spray gun may be determined, relative to the beacon.

In a further example, the device further comprises an angular position sensor arranged to determine a first angular position of the device, wherein the processing unit is further arranged to determine, based on the first angular position and the localisation data, a device angular position of the device relative to the beacons. Such angular position sensor may be a gyroscope. This example allows to provide additional information for reconstruction of the surface to be coated. For this purpose, the data obtained by means of the angular position sensor may be combined with other acquired data and the total of data obtained may be processed together.

In again another example, the scanning surface module comprises a first distance sensor arranged to provide a first distance signal indicating a first distance to the surface in a first direction, the first signal being comprised by the scanning data and the processing unit is further arranged to determine a distance between at least one of the device and the spray gun on one hand and the surface on the other hand, based on the first distance signal. Maintaining a proper distance between the spray gun and the surface to coat is important for the quality of the coating layer. By monitoring the distance, quality may be monitored. If the distance is beyond a lower or upper boundary, an error signal may be generated as a feedback signal to a user. Furthermore, the distance may be employed to determine position of the surface relative to the beacon or beacons, combined with the localisation data.

In yet another example, the scanning surface module further comprises a second distance sensor arranged to provide a second distance signal indicating a second distance to the surface in a second direction, a third distance sensor arranged to provide a third distance signal indicating a third distance to the surface in a third direction, wherein the first direction, the second direction and the third direction a substantially parallel to one another and the processing unit is further arranged to determine, based on the first distance signal, the second distance signal and the third distance signal, scanning angular data indicating an angle of the device relative to the surface. With substantially parallel is meant that from at least one of differences in distances obtained from the distance sensors and variations in these distances over time, an angle of the device and/or the spray gun relative to the surface to be coated may be obtained.

In a further example, the processing unit is further arranged to obtain the localisation data and the scanning data over time; and determine a trajectory of the spray gun relative to the surface over time, based on the localisation data and the scanning data over time. With determining a trajectory of the spray gun over time relative to the surface, deposition of coating fluid over time on the surface may be determined or reconstructed.

In yet a further example, the processing unit is further arranged to obtain at least one of the scanning angular data and the device angular position over time; and determine the trajectory of the spray gun relative to the surface over time, further based on at least one of the scanning angular data and the angular device data over time. This example allows more accurate determining of the trajectory.

In again another example, the processing unit is further arranged to obtain the localisation data and the scanning data over time; and determine a structure of the surface relative to the beacons. This allows for modelling of the surface to be coated. In turn, this may aid in reconstruction of a layer of coating to be deposited or which has been deposited on the surface.

In again a further example, the processing unit is further arranged to obtain at least one of the scanning angular data and the device angular position over time; and determine the trajectory of the spray gun relative to the surface over time, further based on at least one of the scanning angular data and the angular device data over time. This example allows more accurate determining of the trajectory.

In another example, the device comprises a first accelerometer for determining a first acceleration substantially perpendicular to the spray direction and a second accelerometer for determining a second acceleration substantially perpendicular to the spray direction, the first direction being substantially perpendicular to the second direction, wherein the processing unit is further arranged to integrate the first acceleration in time twice over time for obtaining first displacement data in the first direction as a first part of accelerometer position data, integrate the second acceleration in time twice over time for obtaining second displacement data in the second direction as a second part of the accelerometer position data; and determine the localisation data based on the beacon data and the accelerometer position data. This example allows for example to fill in gaps on localisation data at time intervals where beacon data may be missing.

In yet another example, the processing unit is further arranged to: obtain, from an electronic memory, three-dimensional coating model data of a spray cone associated with the spray gun and calculate, based on the trajectory and the three-dimensional coating model, coating deposition area data of positional spray coating deposition on an area of the physical surface per unit of time. This example provides data allowing to reconstruct a layer of coating deposited.

In again a further example, the trajectory is provided with first timestamp data and the processing unit is further arranged to obtain coating fluid flow data provided with second timestamp data, the fluid flow data providing an indication of a mass flow rate of the coating fluid through the spray gun, adjust the coating model data based on the coating fluid flow data, matching the fluid flow data and the trajectory based on the first timestamp and the second timestamp and calculating, based on the scanning data, the trajectory and the three-dimensional coating model, coating deposition area data of positional spray coating deposition on an area of the surface per unit of time. This example allows to reconstruct coating deposited, allowing for example for detailed feedback to an operator or to a customer.

In a further example, the processing unit is further arranged to obtain curing data related to the coating fluid, calculate, based on the coating deposition area data of positional spray coating deposition on the area of the physical surface per unit of time, thickness of a layer of coating fluid on the physical surface; and based on the curing data, determining cured thickness of a cured layer of coating fluid on the surface. The final layer after deposition and curing may have a thickness different from the actually deposited layer of coating fluid, whereas the actual final thickness of the layer is of particular relevance for a customer or other interested party like an insurance company. This example addresses this issue.

A second aspect provides a method of obtaining data on a position of a spray gun relative to a surface provided in a space. The method comprises receiving beacon data from a beacon sensor module arranged to receive beacon data from one or more reflective beacons located in the space; receiving scanning data from a surface scanning module arranged to scan the surface and to provide the scanning data by scanning the surface; and based on the localisation data and the scanning data, determine position data indicating a position of the spray gun relative to the surface.

A third aspect provides a computer program product comprising computer executable instructions causing a computer, when the instructions are executed by a processor comprised by the computer, to execute a method of obtaining data on a position of a spray gun relative to a surface provided in a space, for example the method according to the second aspect.

A fourth aspect provides a non-transitory medium having stored thereon computer program product comprising computer executable instructions causing a computer, when the instructions are executed by a processor comprised by the computer, to execute a method of obtaining data on a position of a spray gun relative to a surface provided in a space, the method may for example be the method of the second aspect.

### BRIEF DESCRIPTION OF THE DRAWINGS

The various aspects and embodiments thereof will now be discussed in further details in conjunction with drawings. The drawings show possible implementations of the various aspects and embodiments thereof and are provided as examples and not as any limitation to the subject-matter of the claims. In the Figures,

FIG. 1: shows a schematic overview of an example of a sensor kit, a spray gun and a surface;

FIG. 2: shows a flowchart of a method for generating a feedback signal in a sensor kit for a spray gun;

FIG. 3A to 3F: show various examples of orientations of the nozzle and cross-sections of the surface to coat and the spray cone.

### DETAILED DESCRIPTION

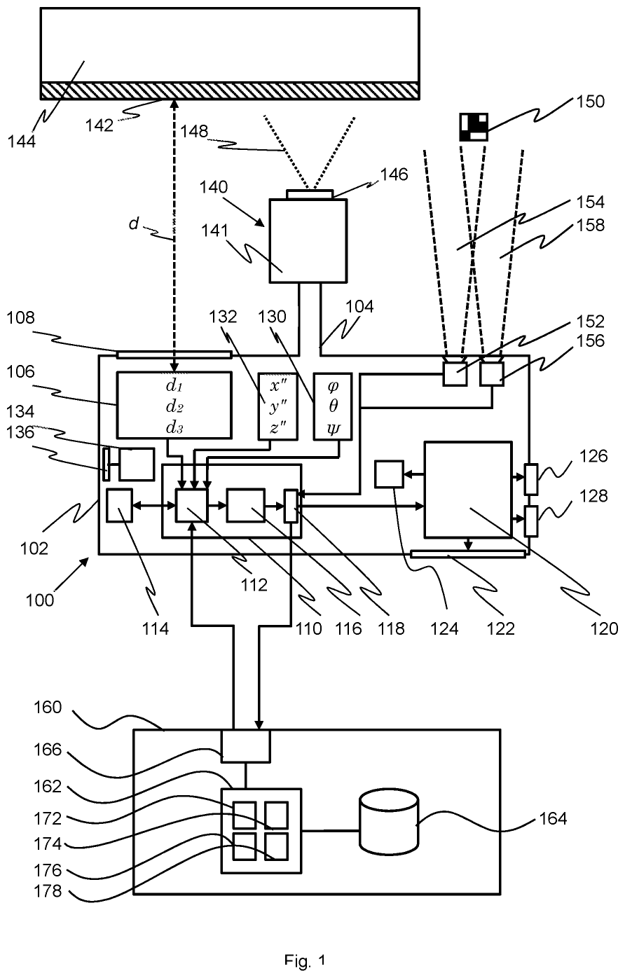

FIG. 1 depicts a schematic overview of an embodiment of a sensor kit 100 as an implementation of the device of the first aspect. The sensor kit 100 comprises a sensor kit body 102 as a housing. The sensor kit body 102 comprises a spray gun connector 104 as a connection module. A spray gun 140 is connected to the body 102 via the connector 104. The spray gun 140 comprises a spray gun housing 141. The spray gun 140 may for example be a High Volume Low Pressure (HVLP) spray gun.

Although the sensor kit body 102 is in FIG. 1 depicted schematically as a rectangle, in different embodiments the body 102 may have a different shape. For example, the body 102 can be shaped around the shape of the spray gun housing 141 to which it is arranged to be connected. The shape of the body 102 and/or centre of gravity of the sensor kit 100 may also be adapted such that, when attached to spray gun 140, the centre of gravity of the spray gun 140 is kept within a desired range. As such, handling of the spray gun 140 may be minimally affected by connecting the sensor kit 100.

The spray gun 140 may be used for applying a layer of paint 142 as a coating on a car body part 144 as a surface. The spray gun 140 comprises a nozzle 146 from which a mist of aerosol paint 148 can be expelled, and an input for receiving the paint as a coating substance. The spray gun 140 may be a hand-held spray gun 140, comprising a trigger which a user can operate to control expelling of paint 148 from the spray gun 140 at a certain rate.

The trigger may control a throughput area of a conduit leading paint or another coating fluid to the nozzle. Alternatively or additionally, the trigger—or another trigger or a control knob—may control a position of a control needle in a throughput orifice, for example the nozzle 146 or another orifice. In one embodiment, a control needle may be used to accurately control a flow of coating fluid and a trigger may be used to switch between an “on” an “off” state of the nozzle. In addition to the accurate control mechanism, the flow of coating fluid may also be controlled by varying pressure under which the coating fluid is provided. One or more of the precision control settings, the coating fluid pressure and the trigger state may be considered as optional spray job parameters.

The user can move and re-orientate the spray gun 140 as desired, and thus move it further away from the car body part 144 or closer to the car body part 144 with a certain speed and acceleration. The user can further orientate the spray gun 140 as desired, and thus change the orientation of the nozzle 146 relative to the car body part 144 such that paint can be applied from different angles of approach.

Provided in the sensor kit body 102 is a distance sensor module 106 comprising one or more time-of-flight sensors as proximity sensors comprised by the distance sensor module 106. The time-of-flight sensors are arranged for obtaining distance data as spray job parameter values on distances d1, d2 and d3 between each of the sensors and the car body part 144 and/or the layer of paint 142. As such, the time-of-flight sensors in the distance sensor module 106 preferably face the same direction as the nozzle 146 when the sensor kit 100 is connected to the spray gun 140, as the nozzle 146 will also face the car body part 144 and/or the layer of paint 142. In other words, the distances are determined in directions substantially parallel to one another.

The time-of-flight sensors as the proximity sensor may comprise a laser or LED as an optical transmitter arranged to emit a laser beam as an emitted optical signal. The time-of-flight sensors may further comprise an optical receiver for receiving a reflected optical signal as a reflection of the laser beam. A proximity processor may be used to determine a spray distance between the time-of-flight sensors and the surface 144 based on a relation between the emitted laser beam and the reflected laser beam.

The emitted optical signal may have a near infrared wavelength spectrum, for example between 800 and 1140 nm, more in particular between 900 nm and 1000 nm and most preferably 940 nm. Electromagnetic radiation of such wave is not visible; it may travel through substance that may seem opaque to the human eye, but is transparent for electromagnetic radiation between 900 nm and 1000 nm and 940 nm in particular.

The sensor kit body 102 may comprise non-translucent materials, and as such light emitted by the time-of-flight sensors may be hindered by the sensor kit body 102. In the embodiment of FIG. 1, the sensor kit body 102 comprises as an option an at least partially translucent viewing window 108 through which light emitted by and reflected back to the time-of-flight sensors can pass. Alternatively, at least part of the sensor kit body 102 through which light should pass may be made of material which is at least partially translucent for wavelengths of light used by the time-of-flight sensors, which may for example be wavelengths in the infra-red spectrum.

In one embodiment, the time of flight sensors are spaced apart at such distance that at a normal spraying distance, between 20 centimetres and 50 centimetres, their lights do not interfere. As such, different values for the distances d1, d2 and d3 may be obtained, particular if the sensor kit 100 is tilted relative to the surface of the car body part 144. Optionally, the two, three, four, five or more time of flight sensors are operated intermittently in time, so as to avoid cross-talk. Additionally or alternatively, the two, three, four, five or more time of flight sensors are operated at different frequencies, with narrow-band sensors operable only in the frequency spectrum of the applicable emitter and not operable in the frequency bands of the other sensors.

Additionally or alternatively, other distance sensors may be used in the distance sensor module 106, like stereoscopic optical data capturing sensors, ultrasonic distance sensors, other, or any combination of two or more thereof.

The sensor kit 100 may further comprise a first camera 152 having a first field of view 154 and a second camera 156 having second field of view 158. The first camera 152 and the second camera 156 are arranged such that the first field of view 154 intersects with the second field of view 158. This means that a first plane of view of the first camera 152 intersects with a second plane of view, the first plane of view and the second plane of view being defined as the intersections of a plane, like a surface and the first field of view 154 and the second field of view 158, respectively. The first camera 152 and the second camera 154 provide data to the output module 118.

The first camera 152 and the second camera 156 are arranged to capture visual data related to a visual marker 150 as a passive reflective beacon. The visual marker 150 may be, as depicted by FIG. 1, a two-dimensional binary visual marker. The visual marker 150 depicted by FIG. 1 may be interpreted as a—relatively simple—QR code.

In another implementation, the visual marker 150 may be implemented as a geometric figure, like a square, circle, triangle, other, or a combination of two or more thereof. The visual marker 150 is preferably attached to a wall or a ceiling of a spray cabin in which a spray job is executed. In another implementation, the visual marker 150—or another passive reflective beacon—is otherwise provided at a position fixed relative to the surface to be coated. For example, the visual marker 150 is connected to a roof of a car of which the hood is to be coated. In another example, one or more visual markers 150 are connected to a ship, a dock in which the ship is provided or a quay to which the ship is moored, of which ship the hull or deck is to be coated.

One or more visual markers 150 may be provided. Generally, sufficient light is available in a spray cabin such that light used for illumination of the cabin and the surface to spray, may be reflected by the visual marker such that the reflected light may be captured by the cameras.

In another implementation, only one camera is provided. Such camera may have a fish-eye lens having a very large field of view. The sensor kit 100 may comprise one or more fish-eye lenses. In again another implementation, the sensor kit 100 comprises multiple sets of two or more cameras having overlapping fields of view. The one or more cameras are, optionally in sets of two, connected to the sensor kit 100 or integrated in the sensor kit body 102 such that during normal spray operation, data of one or more of the one or more visual markers 150 may be captured by one or more of the cameras, preferably at least by first camera 152 and the second camera 156, such that the visual marker 150 is visible in the intersectional part of the first field of view and the second field of view.

In another implementation, other reflective and preferably passive reflective beacons are used. Such may be beacons that otherwise reflect light or other electromagnetic waves, beacons that reflect ultrasonic waves, other beacons or a combination of two or more thereof. For the avoidance of doubt, the light reflected by the beacon that may be detected by the first camera 152 and the second camera 156 may be light visible to the human eye, near-ultraviolet light or near-infrared light.

In one implementation, beacons may be used that are arranged to receive electromagnetic waves in the radiofrequency domain, store the energy of the received waves, use the energy to generate a signal identifying the beacons and emit electromagnetic waves with the generated signal modulated thereon. The modulation may be one of frequency modulate, amplitude modulation, phase modulation, other, or a combination of two or more thereof. The modulation may be digital, binary, analogue, or a combination thereof.

In the embodiment of FIG. 1, the sensor kit 100 comprises a microcontroller 110 as a processing unit. The microcontroller 110 comprises a data input 112 as an input module, arranged to receive one or more reference parameter values. The received reference parameter values may be stored on a memory 114. Distance data may be sent by the time-of-flight sensor 106 to the data input 112 of the microcontroller 110, and also optionally stored on the memory 114.

The microcontroller 110 is in the embodiment of the sensor kit 100 provided inside the sensor kit body 102. Embodiments of the sensor kit 100 are also envisioned wherein another microcontroller as part of the processing unit is provided outside the sensor kit body 102. This other microcontroller may for example be comprised by one or more external computer devices, such as a server, smartphone, tablet, any other computer device, or any combination thereof.

When at least part of the processing unit is provided outside the sensor kit body 102, a wired or wireless connection may be provided between the sensor module and the microcontroller 110 such that exchange of data is made possible. When a wireless connection is used, for example an NFC, Bluetooth, Wi-Fi or any other protocol can be used for exchange of data.

The microcontroller 112 as a processing unit further comprises a comparison module 116 arranged to compare at least part of the obtained spray job parameter values to corresponding one or more reference parameter values. The comparison module 116 may thus be arranged to receive at least part of the spray job parameter values and at least part of the reference parameter values, for example from the data input 112, and/or retrieve at least part of the spray job parameter values and at least part of the reference parameter values from the memory 114.

For obtaining orientation data indicative of an orientation of the spray gun 140, embodiments of the sensor kit 100 may comprise an orientation sensor 130 which may be an absolute or a relative orientation sensor 130. The orientation sensor 130 may comprise a magnetometer, accelerometer, compass, gyroscope, any other sensor or any combination thereof. The orientation sensor 130 is arranged to measure angles of the sensor kit and preferably an angle relative to a horizontal plane. Preferably, the orientation sensor is arranged to provide three signals indicative of a first rotation φ over a first axis perpendicular to the spray direction of the nozzle 146, a second rotation θ over a second axis perpendicular to the spray direction and perpendicular to the first axis and a third rotation Ψ over a third axis parallel to the spray direction.

As such, the orientation data may comprise data indicative of a roll, yaw and pitch of the spray gun 140. Because the housing body 102 is preferably rigidly connected to the spray gun 140, the roll, yaw, and pitch of the orientation sensor 130 may substantially correspond to the roll, yaw, and pitch of the spray gun 140 or may at least be transformed to the roll, yaw, and pitch of the spray gun 140. Any output parameter or parameters of the orientation sensor 130 may be considered as optional spray job parameters.

Additionally or alternatively, the orientation sensor 130 is arranged to determine at least one angle of the orientation sensor relative to a reference plane. The reference plane may for example be a horizontal plane, a vertical plane, or a plane representing the surface 144 on which the coating 142 is to be applied.

For obtaining movement data indicative of a movement of the spray gun 140, embodiments of the sensor kit 100 may comprise an accelerometer 132 as an example of a movement sensor. The accelerometer 132 is preferably arranged to provide three signals indicative of accelerations in three directions. In a preferred implementation, a first acceleration is measured in a first direction x, a second direction y and a third direction z. In a more preferred embodiment, each direction is parallel to an axis of rotation as discussed above. For example, the first direction is parallel to the first axis, the second direction is parallel to the second axis and the third direction is parallel to the third axis, though other options may be envisaged as well.

The movement data may comprise data indicative of a speed and/or acceleration and/or displacement of the spray gun 140 in one or more directions. Because the housing body 102 is preferably rigidly connected to the spray gun 140, the speed and/or acceleration of the movement sensor 132 may substantially correspond to the speed and/or acceleration of the spray gun 140 or may at least be transformed to the speed and/or acceleration of the spray gun 140. One or more of the speed, acceleration and displacement—either as scalar or vector—may be considered as optional spray job parameters.

For powering components of the sensor kit 100 requiring electrical energy, the sensor kit 100 may comprise a battery 134 on which electrical energy may be stored. In particular embodiments, the sensor kit housing 102 is substantially sealed, for example to prevent fluids from entering the housing and/or to prevent electrical components to be exposed to paint fumes. Being substantially sealed, it may not be possible to use a wired connection for charging the battery 134 and/or to easily replace a depleted battery.

A coil 136 as a wireless charging module for charging the battery 134 may be comprised by the sensor kit 100, and may be placed inside the sensor kit housing 102 together with the battery 134. By using for example inductive charging, electrical energy may be supplied to the battery 134 via the coil 136. Because this transfer of electrical energy is wireless, no connector has to be placed in the housing 102 and no electrical components have to be exposed to ambient air which may contain flammable coating substances in aerosols.

The system further comprises a server 160 that may comprise a processing unit 162 and at least have access to a mass memory 164 with stored thereon a database comprising reference parameter values. In further embodiments, at least part of the reference parameter values may already be present on the memory 114 of the sensor kit 100.

The memory 164 may be comprised by the server 160, which may be located at the premises where the spray gun 140 is used or any other place; the mass memory 164 may also be located at another position. The mass memory 164 may also have stored thereon computer executable code for programming the processing unit 162 to execute the method discussed below in conjunction with FIG. 22. As such, the mass memory 164 preferably comprises a non-volatile memory.

The server 160 comprises a communication module 166 for communicating with the sensor kit 100 and in particular with the data output 118 and the data input 112.

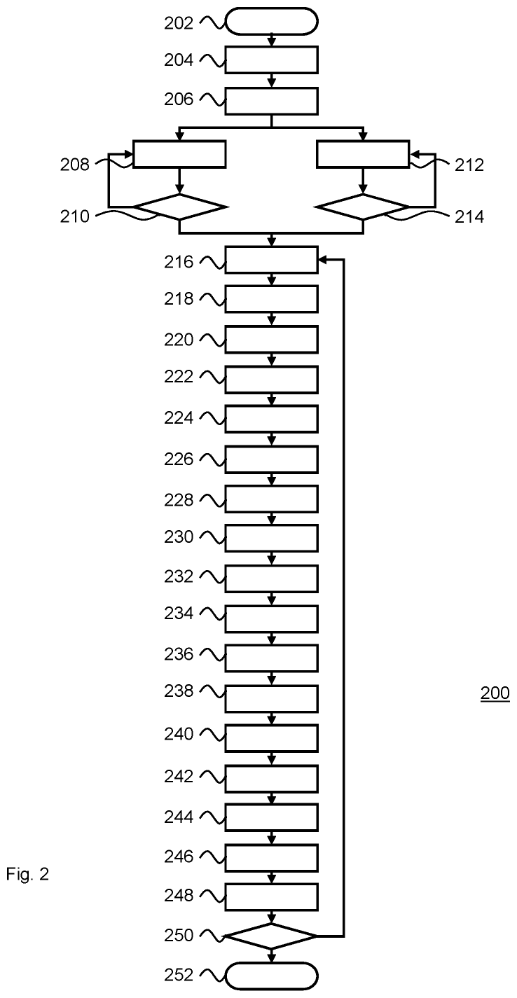

The server 160 further comprises a server processing unit 162, comprising various sub-unit for dedicated tasks. The sub-units may be hardwired or programmed in the processing unit by means of non-volatile (re-)programmable memories or volatile memories. The server processing unit 162 may comprises an integration unit 170, a spatial calculation unit 172, a convolution unit 174, a synchronisation unit 176 and a process calculation unit 178 for performing various functions as discussed in conjunction with a flowchart 200 (FIG. 2) FIG. 2.

The reference parameter values may comprise a set of coating types and corresponding preferred spraying parameters. Spraying parameters may be specific for a type of coatings. For example, for a particular first coating type, a preferred spraying distance between the nozzle 146 and the surface 144 lies within a first distance interval. Preferred spraying parameters may be provided to the sensor kit upon an operator selecting particular coating by means of the server 160.

The reference parameter values may in examples comprise data relating to a minimum and/or maximum speed, orientation, and/or acceleration of the spray gun 140, a minimum or maximum operating temperature and/or pressure, a minimum or maximum flow of coating fluid and/or any other data which may be relevant to a spray job or any combination thereof.

During the use of the spray gun 140, which period of time may be referred to as the spray job, the time-of-flight sensor 106 obtains distance data indicative of the distance d between the time-of-flight sensor 106 and the surface 144 facing the time-of-flight sensor 106.

FIG. 2 depicts a second flowchart 200 of reconstructing coating data, which may be performed in the server system 160 for communicating with a sensor kit 100 for the spray gun 140, or on a different computer device such as a smartphone or tablet computer. The various parts of the flowchart 200 may be executed on at least one of the microcontroller 110 and the processing unit 162. The various parts of the second flowchart 200 are briefly summarised below:
202 Start
204 Obtain coating data
206 Obtain paint model data
208 Monitor acceleration data
210 Zero crossing?
212 Monitor flow data
214 Flow?
216 Monitor distance data
218 Monitor rotational data
220 Monitor acceleration data
222 Monitor beacon data
224 Monitor flow data
226 Calculate movement data
228 Determine localisation data
320 Determine surface orientation
432 Determine angle to surface
234 Determine position data
236 Calculate intersection surface to spray cone
238 Determine coat parameters in intersection plane
240 Synchronise flow data and sensor kit data
242 Calculate coating deposition rate in intersection plane
244 Calculate coating layer thickness on surface
246 Calculate cured layer thickness on surface
248 Monitor flow data
250 Flow?
252 End

The process starts in a terminator 202 and continues with step 204 in which coating data is obtained. Such coating data may be obtained on received data from a user of the spray gun 140. The input may be provided manually, by receiving data from a keyboard, by means of a barcode scanner, by receiving input through selection of an icon, other, or a combination thereof. The coating data comprises characteristics specifically related to at least one of the coating liquid, like viscosity, brand name, solution liquid content, data on layer thickness reduction over curing, desired distance to the surface to coat, other, or a combination thereof.

In step 206, paint model data is obtained. The paint model data comprises data mainly related to the spray gun 140. The paint model data comprises data on the structure of the spray gun 140 and the structure of a spray cone provided by the nozzle 146. The data may be two-dimensional, only perpendicular to the direction of spraying, or three-dimensional. The paint model data may comprise average flow density, median flow density, maximum flow density, minimum flow density, flow density as a function of location within the cone, cone apex, cone shape (circular or non-circular elliptical) and one or more of these parameters having a value depending on distance from the spray gun 140 or the nozzle 141 to the surface of the car body part, coating material characteristics, air pressure, air flow, air flow velocity, other, or a combination thereof.

The actual data of the spray cone may be dependent on characteristics of the coating material, air pressure, an amount of movement of a trigger of the spray gun 140, distance to the car body part 144, other, or a combination thereof. The paint model data may be obtained in the same fashion as the coating data. The data thus described as being obtained may be obtained from the mass memory 214 by the processing unit 162.

In step 208, acceleration data as received from the accelerometer 132 as comprised by the sensor kit 100 is monitored. If the acceleration in a particular direction, in particular in a direction perpendicular to the spray direction and in a left-right direction when the spray gun 140 is held by an operator, crosses zero at least one time and preferably two or more times, it is detected, in step 210, that the spray gun 140 is in use for spraying.

To reduce a risk of erroneous detection, the detection of zero crossings of the acceleration value may be combined with determining that the time period between two or more subsequent crossings is substantially the same. In this way, a swinging movement of the spray gun 140 may be detected as an indication of the operator executing a paint job.

Alternatively or additionally, flow data may be monitored. Flow data may be monitored by monitoring whether a trigger of the spray gun 140 is pulled, for example by receiving a signal from a trigger sensor (not shown), which may be a binary, otherwise digital or analogue continues signal. The flow rate may be provided with a timestamp, providing indications of the flow rate at multiple, for example consecutive, moments in time.

From the flow data, a mass flow rate or a volume flow rate through the nozzle may be determined, for example based on stored values of density of the coating fluid. By determining whether the trigger is opened or not and combining the determined state of the trigger with a nominal flow rate of the nozzle, optionally at one or more pressures of air of the air provided to the spray gun 140, a total mass flow rate or a total volume flow rate may be determined at a particular moment the trigger is operated. By determining how far or how much the trigger is operated, combined with a relation between trigger operation and mass flow rate or volume flow rate, an actual flow rate at a particular moment may be determined. Flow may also be sensed between a coating fluid reservoir and the spray gun 140.

Alternatively or additionally, at least one of a flow of air and a flow of coating material may be monitored by means of a sensor (not shown) in step 224 and the signal provided by such sensor may be monitored by means of the processing unit 162. The total flow data—mass flow (rate) or volume flow (rate)—may thus be obtained directly by means of a sensor.

If at least one of a flow of the air, pressing of the trigger and flow of the coating material, is detected, it is determined in step 214 that the spray job has started. In on embodiment, the determination is only made if the signal is detected for a time period longer than a pre-determined time interval.

If, based on evaluation of sensor data, it has been determined that the paint job has started, distance data provided by the distance sensor module 106 is monitored in step 216, rotational data provided by the orientation sensor 130 is monitored in step 218, acceleration data as provided by the accelerometer 130 is monitored in step 220 and flow data provided by sensors as discussed above is monitored in step 224.

In step 222, beacon data is monitored. In the embodiment as depicted by FIG. 1, the first camera 152 and the second camera 156 receive image data—in light—from the visual beacon 150 and convert the image data received to electronic signals. The electronic signals—digital or analogue—are transferred to the microcontroller 110. Subsequently, the electronic signals may be transferred to the processing unit 162 of the server 160—or processing or at least part thereof is done locally in the microcontroller 110.

Visual data may be acquired multiple times per second, for example 5, 10, 20, 25, 40, 50, 75 or 100 times per second. Preferably, image frames are provided with a time stamp for synchronisation purposes. This allows images acquired by the various cameras at the same moment to be compared or otherwise processed. The monitoring steps may be executed in parallel or, intermittently and repeatedly (interweaved), in series.

Based on the accelerometer data, the speed by which the operator moves the spray gun 140 and the distance by which the operation moves the spray gun 140 may be calculated in step 226 by integrating the data received from the accelerometer one or two times over time; this action may be performed by the integration unit 170. Prior to integration, data provided by the accelerometers may be processed using statistical parameters, for example by removing outliers, smoothing a signal over time, for example by determining a moving average or average median, determining what an outlier is, for example based on a standard deviation, for example over time. Alternatively or additionally, the acceleration data signals may be filtered, for example using a Kalman filter. Alternatively or additionally, displacement data is obtained differently, for example using beacons in a spray room.

If the spray gun is properly aimed at the car body part 144, data of acceleration in directions parallel to the car body part 144 is sufficient as the spray direction is always to be perpendicular to the surface of the car body part. However, this may not always be the case, for which reason it is preferred to process acceleration in all directions.

In step 228, localisation data is determined. The localisation data is determined based on the beacon data. In the implementation depicted by FIG. 1, image data of the visual marker 150 that has been acquired by means of the first camera 152—first image data—and the second camera 156—second image data—is analysed. Within image frames acquired at the same moment, data received from the visual marker 150 is identified. Data within an acquired image frame may be analysed using image analysis and data augmentation technology to identify data related to the visual marker 150 within the image frame. Next, data related to the visual marker 150 may be compared to at least one of reference data and data related to the visual marker 150.

Based on differences between image data acquired—for example the first image data—and a reference—either a reference image retrieved from the device memory 114 or the server memory 164 or the second image data—, an orientation of the spray gun 140 in the spray cabin may be determined. Based on the comparing and differences between the image to be compared and the reference image, skew, rotation, pitch variation, roll variation, altitude variation, size difference, other or any combination of two or more thereof, a distance between the camera and the visual marker 150 may be determined. Additionally or alternatively, a angular position of the sensor kit 100 relative to the visual marker 150 may be determined. The angular position thus determined may be corrected, adjusted or refined using data from the rotation sensor 132, providing updated localisation data.

Furthermore, additionally or alternatively, an actual position of the first camera 152 and the second camera 156—and with that, of the spray gun 140—relative to the visual marker 150 with a fixed position in the spray cabin may be determined. The result of this determining may be provided in at least one of cartesian or polar coordinates, with two or three numbers in a set. Additionally or alternatively, a rotation over one, two or three axes may be determined, based on the beacon data provided by the first camera 152 and the second camera 156 and the comparing of image data acquired by the cameras.

Within a spray cabin, multiple visual markers may be provided. The markers may be the same or having different shapes depicted thereon. In the latter case, with fixed or pre-determined known locations of the visual markers, more accurate determining of a position may be obtained, as more data is available. Additionally or alternatively, less cameras may be required on the sensor kit 100. A reason for the latter point is that for proper determination of a position of the sensor kit 100—and with that, of the spray gun 140—, at least one camera should be able to capture an image of at least one visual marker. With multiple visual markers available, the odds of a single camera capturing at least one visual marker irrespective of position and angle of the sensor kit 100 are higher than with only a single marker in a spray cabin.

In step 230 may, optionally, orientation of surface of the car body part 144 be determined. In one implementation, the surface is assumed to be horizontal or vertical.

In another implementation, the spray gun is assumed to be mainly held in a fashion perpendicular to the surface. Based on the orientation data provided by the orientation sensor 130, the orientation of the surface may be determined, under an assumption that the spray gun 140, at least on average, follows the surface.

In step 232 orientation of the spray gun 140 relative to the surface of the car body part 144 may be determined. In one implementation, data on the distance to the surface may be taken into account. If the distance sensor module 106 comprises multiple time of flight sensor or other sensors having equivalent functionality and all measured distances are the same, the spray gun 140 is aimed perpendicularly at the surface. If the distances are different, an orientation of the spray gun 140 or the orientation of the spray cone provided by the nozzle 146 may be determined, other than perpendicular.

In an implementation wherein the surface is assumed to be horizontal or vertical, using data from the orientation sensor 130, over one or more axes, may be used to determine an orientation of the spray gun relative to the surface.

In another implementation, where the orientation of the surface is determined using the data from the orientation sensor module 130, the orientation of the spray gun 140 relative to the surface may be determined by detecting deviations in the signal from the orientation sensors from an average obtained over time, for example over two, five or ten seconds.

In step 234, position data indicating a position of the spray gun 140 relative to the car body part 144 and in particular the surface thereof is determined. This determining is in this example based on the localisation data determined in step 232 and scanning data acquired by means of the distance sensor module 106. The position data indicates a position of the spray gun 140 relative to the car body part 144 and in particular the surface thereof.

Whereas a position may be calculated using double integration over time using the data from the accelerometer 132, position data over time using the beacon data over time may be more reliable for determining a trajectory of the spray gun 140—and with that, a spray cone emitted by the nozzle 146—relative to the surface of the car body part 144 may be determined in a more accurate way. The accelerometer may be used for one or more of enhancing, refining, correcting, complementing, or adjusting position data determined based on the beacon data—or vice versa.

In the case of complementing data, data received from the accelerometer may, processed like twice integrated over time, or unprocessed, be used to complement data for particular data intervals during which no beacon data or unreliable beacon data is available. Beacon data may be characterised as unreliable if to much variations and/or too large variations are sensed within a particular timeframe. This implementation may also be used the other way around, the beacon data may be used to complement accelerometer data if the latter is determined to be not available or not reliable.

In case of adjustment, determining of location based on double integration of acceleration over time may result in drift of localisation data. Beacon data may be used to adjust or correct the localisation data, thus eliminating or at least reducing the effects of the drift.

The angle of the spray gun 140 and the nozzle 146 in particular relative to the surface of the car body part 144 may be determined using data provided by at least one of the orientation sensor 130 and the distance sensor module 106. Using the distance sensor module 106, an angle of the spray gun 140 relative to the surface of the car body part 144 may be determined by obtaining differences between the distances determined by the different sensors provided within the distance sensor module 106. With data from three or more sensors, angles in two directions may be determined as part of the position data, additionally or alternatively to data related to distance between the spray gun 140 and the surface of the car body part.

The acquired momentary position data of the spray gun, comprising at least one of angle and distance relative to the surface of the car body part 144, combined with the localisation data, acquired over time, may be used to model a shape of the car body part 144, for example in the spray cabin.

Based on the data calculated in at last one of step 232 and step 234, data from the distance sensor module 106, the paint model data, coating data, other, or a combination thereof, an intersection or intersection plane of the spray cone and the surface of the car body part 144 is determined in step 236; this action may be performed by the spatial calculation unit 172. With the information of the intersection plane, coating parameters in the intersection plane may be determined, taking into account the paint model data and, optionally, the coating data.

With the paint model comprising flow density data as a function of a location in the cone, in a numerical representation, analytical representation, other, or a combination thereof, coat parameters and in particular data related to flow density may be determined in step 238. For particular locations in the intersection plane, mass or coat volume per volume per reference point per second or other time unit may be determined. In this way, deposition of coating, in mass, volume, or both, per unit area per unit time may be determined in step 242.

Optionally, flow data may be taken into account in the deposition model, if such data is available and varies over time. Preferably, the flow data and the data from the sensor kit 100 is synchronised over time in step 240, prior to determining the deposition rate per unit area per time; this may be handled by the synchronisation unit 176. The data from the sensor kit 100 and the data from a sensor providing a signal indicative of flow of coating material may be time stamped using network data, from a network over which both sensor packages provided data to the server 160. Other sources of time and preferably a single time source or multiple synchronised time sources may be considered as well.

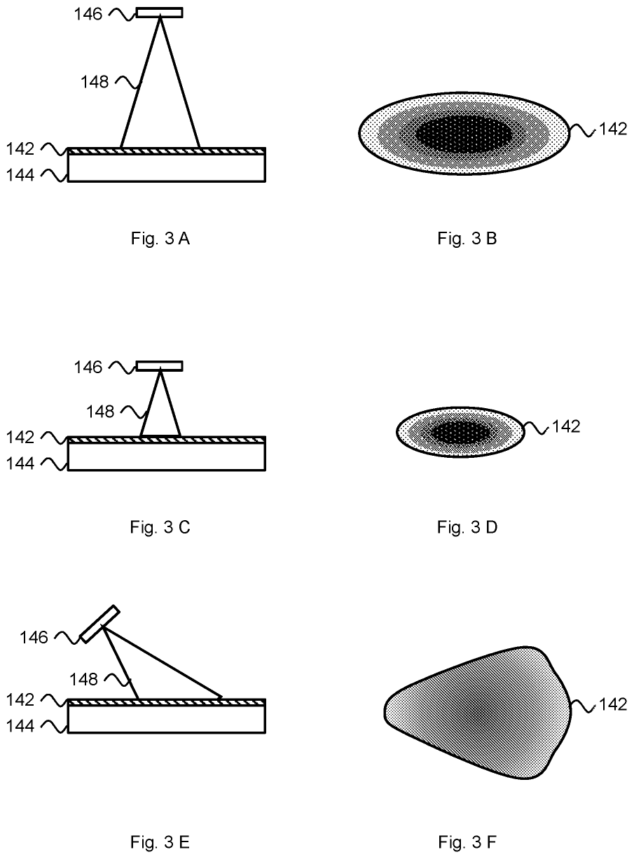

FIG. 3A through FIG. 3F depict the result of step 238. FIG. 3A shows the nozzle 146 providing a spray cone 148 at a first distance towards the surface of the car body part 144, depositing a layer 142 of coating material. FIG. 3B shows an indication of flow density in the plane where the spray cone 148 intersects the surface. The darker the colour, the higher the flow rate density. In FIG. 3B, the spray cone is assumed to have an elliptical, non-circular cross-section, which corresponds to a significant amount of spray-guns commercially available. Alternatively, the spray cone as defined by the paint model data may have a circular cross-section.

FIG. 3C shows the nozzle 146 at a second distance from the surface, the second distance being smaller than the first distance shown in FIG. 3A. the smaller distance results in a smaller cross-sectional area in the cross-section between the spray cone 148 and the surface of the car body part 144. Hence, the elliptical spray density as depicted by FIG. 3D is smaller.

The density distribution within the cross-sectional area is equivalent. It is noted that the total density, over the whole cross-sectional area, i.e. the integration of the flow density per unit area over the area over the cross-sectional area, is preferably the same for FIG. 3B and FIG. 3D. In another implementation, loss of coating material per distance away from the nozzle 146 may be taken into account.

FIG. 3E shows the nozzle 146 being placed under and angle relative to the surface of the car body part 144. With an elliptical cross-section of the spray cone 148, this may result in a cross-sectional area 142 as depicted by FIG. 3F. In further implementations, occlusions due obstructions protruding from the surface or indentations in the surface may also be taken into account when determining deposition of coating on the surface per unit area and per unit time.

Next, taking into account the data as depicted by FIG. 3B, FIG. 3D and FIG. 3F—whichever may be applicable—, the movement data or displacement data obtained by dual integration of the acceleration data—or other data indicative of movement—and time, the total amount of deposited coating material may be determined in step 244. One option to do so is by convolution of the movement of the spray gun over time and the deposition rate over time, which may be handled by the convolution unit 174. Also other data may be taken into account, including, but not limited to ambient pressure, ambient temperature, humidity.

In the convolution step, different data sets may be used. One example is using localisation data determined based on assessment of beacon data acquired over time. Another example is using movement data acquired by double integration of acceleration data. In a further example, data acquired as beacon data and accelerometer data is combined. In yet a further example, rotation data acquired by means of the rotation sensor 134 is used.

In again another example, scanning data, for example acquired using the distance sensor module 106 is used, providing distance and angle relative to the surface of the car body part is used. Data thus acquired, calculated, determined or otherwise obtained may be combined in any way, using averages, other statistical parameters or other algorithms, to provide a trajectory of the nozzle 146, the spray cone 148 and/or the spray gun 140 as a basis for the convolution step or another step to determine deposition of coating fluid over time on the surface of the car body part 144.

In step 246, coating data on curing of the coating material may be used to determine, based on the result of step 244, a thickness of the coating layer after curing, by the process calculation unit 178.

The process as discussed above may be executed continuously, while spraying continues. In particular determining final coating thickness, before or after curing, may be determined after the coating process is finished. Alternatively, some steps are executed when the spray job is finished.

An end of the spray job may be determined as a point when monitored flow data indicates that no flow is present, momentarily or during a particular time interval. Alternatively or additionally, absence of detection of a swinging motion, as discussed above, may also be considered for determining that the spray process has ended in step 250. Once the process is finalised, the procedure ends in a terminator 252.

In summary, the various aspects and implementations thereof relate to reconstruction of a layer of coating; by measuring a position of a spray gun relative to a physical surface to coat, using data on technical characteristics of the spray gun, like a spray cone the spray gun may produce and data on a coating fluid used, characteristics of a coating layer thus physically deposited may be reconstructed. With data being recording during the spray job, this is faster and more accurate than measuring layer thickness at various locations, either pre-determined or randomly. By determining flow characteristics in a spray cone and position of the spray cone relative to the surface over time and using a model of the spray cone, deposition of the layer of coating may be determined and the final layer, cured or uncured, may be reconstructed, including thickness.

1. A system for obtaining data on a position of a spray gun relative to a surface provided in a space, comprising a device comprising:
a spray gun mount arranged to rigidly connect the device to the spray gun;
a beacon sensor module arranged to receive beacon data from one or more reflective beacons located in the space;
a surface scanning module arranged to scan the surface and to provide scanning data by scanning the surface;
the system further comprising an electronic processing unit arranged to:
receive the beacon data;
based on the beacon data, determine localisation data indicating a location of the device within the space; and
based on the localisation data and the scanning data, determine position data indicating a position of the spray gun relative to the surface.

2. The system according to claim 1, wherein:
the beacon sensor module comprises a first optical sensor arranged to
capture light reflected by a visual beacon and to provide first image data representing the reflected light; and
the processing unit is further arranged to:
identify data related to the beacon in the first image data as first received beacon data;
obtain beacon reference data;
compare the received beacon data to the beacon reference data;
based on the comparing, determine a relative position of the device relative to the beacon; and
provide the determined position as localisation data.

3. The system according to claim 1, wherein:
the beacon sensor module comprises a first optical sensor having a first field of view and a second optical sensor having a second field of view, the first field of view overlapping at least partially with the second field of view; and
the processing unit is further arranged to:
identify data related to the beacon in the first image data as first received beacon data;
identify data related to the beacon in the second image data as second received beacon data;
compare the first received beacon data to at least one of the second received beacon data and reference beacon data;
based on the comparing, determine a relative position of the device relative to the beacon; and
provide the determined position as localisation data.

4. The system according to claim 1, wherein the processing unit is further arranged to determine, based on the beacon data, a beacon angular position of the device relative to the beacons or beacons as part of the localisation data.

5. The system according to claim 1, wherein the localisation data comprises one or more of the following parameters:
distance to the beacon;
two or more cartesian coordinate values;
an angular position of the device relative to the beacon.

6. The system according to claim 1, the device further comprising an angular position sensor arranged to determine a first angular position of the device, wherein the processing unit is further arranged to determine, based on the first angular position and the localisation data, device angular data indicating a device angular position of the device relative to the beacons.

7. The system according to claim 1, wherein:
the scanning surface module comprises a first distance sensor arranged to provide a first distance signal indicating a first distance to the surface in a first direction, the first signal being comprised by the scanning data; and
the processing unit is further arranged to determine a distance between at least one of the device and the spray gun on one hand and the surface on the other hand, based on the first distance signal.

8. The system according to claim 7, wherein:
the scanning surface module further comprises:
a second distance sensor arranged to provide a second distance signal indicating a second distance to the surface in a second direction,
a third distance sensor arranged to provide a third distance signal indicating a third distance to the surface in a third direction,
the first direction, the second direction and the third direction a substantially parallel to one another; and
the processing unit is further arranged to determine, based on the first distance signal, the second distance signal and the third distance signal, scanning angular data indicating an angle of the device relative to the surface.

9. The system according to claim 1, wherein the processing unit is further arranged to:
obtain the localisation data and the scanning data over time; and
determine a trajectory of the spray gun relative to the surface over time, based on the localisation data and the scanning data over time.

10. The system of claim 9, the device further comprising an angular position sensor arranged to determine a first angular position of the device, wherein the processing unit is further arranged to determine, based on the first angular position and the localisation data, device angular data indicating a device angular position of the device relative to the beacons, wherein
the scanning surface module further comprises:
a second distance sensor arranged to provide a second distance signal indicating a second distance to the surface in a second direction,
a third distance sensor arranged to provide a third distance signal indicating a third distance to the surface in a third direction,
the first direction, the second direction and the third direction a substantially parallel to one another; and
the processing unit is further arranged to determine, based on the first distance signal, the second distance signal and the third distance signal, scanning angular data indicating an angle of the device relative to the surface; and
the processing unit is further arranged to:
obtain at least one of the scanning angular data and the device angular position over time; and
determine the trajectory of the spray gun relative to the surface over time, further based on at least one of the scanning angular data and the angular device data over time.

11. The system according to claim 1, wherein the processing unit is further arranged to:
obtain the localisation data and the scanning data over time; and
determine a structure of the surface relative to the beacons.

12. The system of claim 11, the device further comprising an angular position sensor arranged to determine a first angular position of the device, wherein the processing unit is further arranged to determine, based on the first angular position and the localisation data, device angular data indicating a device angular position of the device relative to the beacons, wherein
the scanning surface module further comprises:
a second distance sensor arranged to provide a second distance signal indicating a second distance to the surface in a second direction,
a third distance sensor arranged to provide a third distance signal indicating a third distance to the surface in a third direction,
the first direction, the second direction and the third direction a substantially parallel to one another; and
the processing unit is further arranged to determine, based on the first distance signal, the second distance signal and the third distance signal, scanning angular data indicating an angle of the device relative to the surface; and
the processing unit is further arranged to:
obtain at least one of the scanning angular data and the device angular position over time; and
determine the trajectory of the spray gun relative to the surface over time, further based on at least one of the scanning angular data and the angular device data over time.

13. The system according to claim 1, further comprising at least one reflective beacon.

14. The system according to claim 13, wherein the beacon comprises at least one of:
a two-dimensional visual binary code;
an electronic device arranged to emit an emitted electromagnetic signal upon receiving a received electromagnetic signal from the device;
a visualisation of a geometric figure.

15. The system according to claim 1, wherein the device comprises a first accelerometer for determining a first acceleration substantially perpendicular to the spray direction and a second accelerometer for determining a second acceleration substantially perpendicular to the spray direction, the first direction being substantially perpendicular to the second direction, wherein the processing unit is further arranged to:
integrate the first acceleration in time twice over time for obtaining first displacement data in the first direction as a first part of accelerometer position data;
integrate the second acceleration in time twice over time for obtaining second displacement data in the second direction as a second part of the accelerometer position data; and
determine the localisation data based on the beacon data and the accelerometer position data.

16. The system of claim 1, wherein the processing unit is further arranged to:
obtain the localisation data and the scanning data over time; and
determine a trajectory of the spray gun relative to the surface over time, based on the localisation data and the scanning data over time;
obtain, from an electronic memory, three-dimensional coating model data of a spray cone associated with the spray gun;
calculate, based on the trajectory and the three-dimensional coating model, coating deposition area data of positional spray coating deposition on an area of the physical surface per unit of time.

17. The system according to claim 16, wherein the trajectory is provided with first timestamp data and the processing unit is further arranged to:
obtain coating fluid flow data provided with second timestamp data, the fluid flow data providing an indication of a mass flow rate of the coating fluid through the spray gun;
adjust the coating model data based on the coating fluid flow data;
matching the fluid flow data and the trajectory based on the first timestamp data and the second timestamp data; and
calculating, based on the scanning data, the trajectory and the three-dimensional coating model, coating deposition area data of positional spray coating deposition on an area of the surface per unit of time.

18. The system according to claim 15, wherein the processing unit is further arranged to:
obtain curing data related to the coating fluid;
calculate, based on the coating deposition area data of positional spray coating deposition on the area of the physical surface per unit of time, thickness of a layer of coating fluid on the physical surface; and
based on the curing data, determining cured thickness of a cured layer of coating fluid on the surface.

19. A method of obtaining data on a position of a spray gun relative to a surface provided in a space, the method comprising:
receiving beacon data from a beacon sensor module arranged to receive beacon data from one or more reflective beacons located in the space;
receiving scanning data from a surface scanning module arranged to scan the surface and to provide the scanning data by scanning the surface; and
based on the localisation data and the scanning data, determine position data indicating a position of the spray gun relative to the surface.

20. (canceled)

21. Non-transitory medium having stored thereon computer program product comprising computer executable instructions causing a computer, when the instructions are executed by a processor comprised by the computer, to execute a method of obtaining data on a position of a spray gun relative to a surface provided in a space, the method comprising:
receiving beacon data from a beacon sensor module arranged to receive beacon data from one or more reflective beacons located in the space;
receiving scanning data from a surface scanning module arranged to scan the surface and to provide the scanning data by scanning the surface; and
based on the localisation data and the scanning data, determine position data indicating a position of the spray gun relative to the surface.
